(19) United States
(12) Patent Application Publication
(10) Pub. No.: US 2025/0036999 A1
(43) Pub. Date: Jan. 30, 2025

(54) QUANTUM APPROXIMATE OPTIMISATION

(71) Applicant: Q-Ctrl Pty Ltd, Sydney (AU)

(72) Inventors: Samuel MARSH, Sydney (AU); Christopher BENTLEY, Sydney (AU); Andre CARVALHO, Sydney (AU)

(21) Appl. No.: 18/715,430

(22) PCT Filed: Nov. 23, 2022
(86) PCT No.: PCT/AU2022/051398

§ 371 Date: May 31, 2024

(30) Foreign Application Priority Data
Dec. 2, 2021 (AU) 2021903901

(51) Int. Cl. G06N 10/60; G06N 10/20; G06N 10/40; G06N 10/70

(52) U.S. Cl. CPC G06N 10/60; G06N 10/20; G06N 10/40; G06N 10/70

(57) ABSTRACT

This disclosure relates to a quantum circuit for quantum approximate optimisation over permutations of a set of elements. Encoding logic encodes each of the elements into multiple quantum registers as a binary number to represent a permutation of the set of elements by storing the binary number of each of the elements in an order according to the permutation. A network of multi-qubit quantum exponential swap operations operates between the multiple qubits of two registers and generates a superposition of two permutations by generating a superposition of two binary numbers by generating a superposition of the multiple qubits of the two quantum registers. An evaluation quantum circuit represents a problem Hamiltonian and distinguishes quantum states of the superposition generated by the network. The network and the evaluation quantum circuit amplify desirable quantum states and suppress undesirable quantum states to optimise over the permutations.

### CROSS-REFERENCE TO RELATED APPLICATIONS

The present application claims priority from Australian Provisional Patent Application No 2021903901 filed on 2 Dec. 2021, the contents of which are incorporated herein by reference in their entirety.

### TECHNICAL FIELD

This disclosure relates to quantum approximate optimisation, such as, the use of a quantum circuit for the exploration of a search space to find an optimal solution.

### BACKGROUND

Quantum computers are expected to revolutionise data processing in the future. However, current quantum computing technology has not yet matured to be applicable for general computing. Therefore, there is a focus for near-term quantum computing applications that are feasible with currently existing technologies.

Quantum optimization algorithms are quantum algorithms that are used to solve optimization problems. Mathematical optimization deals with finding the best solution to a problem (according to some criteria) from a set of possible solutions. Mostly, the optimization problem is formulated as a minimization problem, where one tries to minimize a cost which depends on the solution: the optimal solution has the minimal cost. Different optimization techniques are applied in various fields such as mechanics, economics and engineering, and as the complexity and amount of data involved rise, more efficient ways of solving optimization problems are needed. The power of quantum computing may allow problems which are not practically feasible on classical computers to be solved, or provide a considerable speed up with respect to the best known classical algorithm.

One such type of problem is combinatorial optimisation. One example for such a problem is the MaxCut problem, which starts from a graph with nodes and edges and aims to find a separation of the nodes into two sets so that the number of edges between the sets is minimal. This problem is difficult to solve with classical computers due to its exponential complexity.

It is noted that this disclosure can be implemented on a wide range of technologies, including phosphorous qubits in silicon using nuclear or electron spin states, nitrogen vacancies in diamond, trapped ions, photons, quantum dots, superconducting circuits, and others.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

A quantum circuit for quantum approximate optimisation over permutations of a set of elements comprises:
multiple quantum registers, each of the multiple quantum registers comprising multiple qubits;
an encoding logic configured to encode each of the elements in one of the multiple quantum registers as a binary number to represent a permutation of the set of elements by storing the binary number of each of the elements in an order according to the permutation;
a network of multi-qubit quantum exponential swap operations, each one of the multi-qubit quantum exponential swap operations configured to:
   operate between the multiple qubits of a first quantum register of the multiple quantum registers and the multiple qubits of a second quantum register of the multiple quantum registers, and
   generate a superposition of two permutations by generating a superposition of two binary numbers by generating a superposition of the multiple qubits of the first quantum register storing a first binary number and the multiple qubits of the second quantum register storing a second binary number;
an evaluation quantum circuit representing a problem Hamiltonian to distinguish quantum states of the superposition generated by the network, wherein when in use, the network and the evaluation quantum circuit amplify desirable quantum states and suppress undesirable quantum states to optimise over the permutations.

It is an advantage that the quantum circuit explores the search space of the different permutations efficiently. Further, the encoding of the elements facilitates a reduction in the number of qubits that are required in the quantum circuit.

In some embodiments, the network of quantum exponential swap operations has a structure of a sorting network.

In some embodiments, the structure comprises an odd-even mergesort structure.

In some embodiments, the network is configured to transform any valid permutation state to a quantum superposition of computational basis states, and wherein each computational basis state with non-zero probability in the superposition is a valid permutation state.

In some embodiments, the network comprises a quantum exponential swap operation with non-zero probability between any two valid permutation states.

In some embodiments, the quantum exponential swap operations are tuneable by a parameter indicating the degree of swap in the superposition.

In some embodiments, the parameter is a quantum evolution parameter.

In some embodiments, the action of the circuit is dependent on the series of the swap parameters, which can either be identical or independently tunable for a given network.

In some embodiments, the network of multi-qubit quantum exponential swap operations further comprises a single ancilla qubit to implement a series of quantum swap operations between the first quantum register and the second quantum register.

In some embodiments, the network of multi-qubit quantum exponential swap operations further comprises n/2 ancilla qubits to implement the series of quantum swap operations between multiple registers in parallel, where n is a number of elements.

In some embodiments, the evaluation quantum circuit is configured to apply a phase shift to solutions proportional to a respective quality.

In some embodiments, the phase shift is tuneable by an evaluation parameter.

In some embodiments, the quantum circuit further comprises control circuitry to iteratively optimise an initial permutation by applying the quantum swap operations and the evaluation quantum circuit multiple times until a termination criterion is met.

A method for quantum approximate optimisation over permutations of a set of elements comprises:
encoding each of the elements in one of multiple quantum registers as a binary number, each of the multiple quantum registers comprising multiple qubits, by storing the binary number of each of the elements in an order according to a permutation of the set of elements;
applying multi-qubit quantum exponential swap operations between the multiple qubits of a first quantum register of the multiple quantum registers and the multiple qubits of a second quantum register of the multiple quantum registers, to generate a superposition of two permutations by generating a superposition of two binary numbers by generating a superposition of the multiple qubits of the first quantum register storing a first binary number and the multiple qubits of the second quantum register storing a second binary number;
applying an evaluation quantum circuit representing a problem Hamiltonian to amplify desirable quantum states of the superposition generated by the network and to suppress undesirable states of the superposition generated by the quantum network to optimise over the permutations.

In some embodiments, the method further comprises measuring a result of applying the quantum exponential swap operations and the evaluation quantum circuit to optimise over the permutations based on the result.

In some embodiments, the method further comprises iteratively optimising an initial permutation by, at each iteration, tuning quantum circuit parameters by a classical computer system.

Optional features provided with regards to one aspect of method or circuit, equally apply to the other aspects.

### BRIEF DESCRIPTION OF DRAWINGS

An example will now be described with reference to the following drawings:

FIG. 1 illustrates a method for quantum approximate optimisation over permutations of a set of elements.

FIG. 2a illustrates a quantum circuit for quantum approximate optimisation over permutations of a set of elements.

FIG. 2b illustrates a histogram of measured states, i.e. permutations, over multiple measurements (not all permutations are shown).

FIG. 3a illustrates an example for network 203, which in this case is an odd-even mergesort network on 8 inputs. Between each dashed barrier, the comparators act on independent inputs and can be executed in parallel.

FIG. 3b illustrates a conversion of a classical pairwise comparator to a local quantum mixing operation.

FIG. 3c illustrates an exponential swap of m-qubit registers using a single ancilla qubit, with depth and gate count [symbol] (m).

FIG. 4 illustrates a plot of | [symbol] σₖ|U(β)|σ₀ [symbol] )| for varying β using the odd-even mergesort architecture, where σₖ is the k th permutation of the labels {0,1,2,3} (using lexicographical permutation ordering). There is probability transfer to all 4!=24 valid permutation states.

### DESCRIPTION OF EMBODIMENTS

### Background on QAOA Realizations

Quantum approximate combinatorial optimisation is a viable and important application for noisy intermediate-scale quantum (NISQ) computation. The Quantum Approximate Optimisation Algorithm (QAOA), has the potential to provide near-term quantum advantage. The combinatorial optimisation problems compatible with the QAOA have a wide range of industrial applications, including finance (e.g. constrained portfolio optimisation), transport and logistics (e.g. constrained vehicle routing), communication (e.g. wireless scheduling), chemistry, and health.

QAOA-based algorithms apply an interleaved series of two operators: a problem unitary, which applies a parameter-dependent phase shift to solutions proportional to their quality, and a mixing unitary, which mixes amplitude between solutions to explore the search space. Each operator has an associated classical variational parameter: the aim is to vary these parameters such that the probability of measuring a high-quality solution is amplified.

To map a combinatorial optimisation problem to the QAOA, a qubit encoding of all solutions to the problem instance is derived. However in most cases, the space of solutions spanned by the qubit representation of the problem is much larger (typically exponentially) than the number of valid problem solutions. This can be a result of limited-order inter-qubit interactions, or result from the number of valid solutions not corresponding to a binary power such that the Hilbert space necessarily contains invalid computational basis states.

The issue of a relatively small subspace of valid solutions arises for a wide variety of hard optimisation problems where the solution domain can be described by permutations of a set of elements. First denote a set of combinatorial objects C={c₀, c₁, . . . , cₙ₋₁}. Then we consider the problem of finding a permutation σ*∈Sₙ such that

$$f ( {σ}^{*} ( C ) ) = {min}_{σ ∈ {S}_{n}} f ( σ ( C ) ) , \qquad ( 2 )$$

i.e. to find the permutation with the lowest cost according to the given measure f. This formulation is appropriate for problems including the travelling salesperson problem, job-shop scheduling, and the quadratic assignment problem. Notably we do not require that the elements of the set C are unique, meaning this formulation also encompasses problems involving constrained assignment of set elements to labelled clusters.

For combinatorial optimisation problems of this form, there are n! valid solutions, and thus at least k=log₂(n!)= [symbol] (n log₂n) qubits are used to encode all solutions. The one-hot encoding uses n² qubits, however a more compact permutation encoding can be employed using n log₂n qubits, where the k th block of log₂n qubits encodes the label of an element i, such that the permuted ordering of the elements has cᵢ at position k. Valid states are those where each register contains a label from 0, 1, . . . , n−1. Depending on the application, these labels may or may not be unique. Even for the more compact binary encoding, it can be checked using Stirling's approximation that the feasible subspace is exponentially small— [symbol] (e⁻ⁿ\sqrt{n})—with respect to the dimension of the Hilbert space.

The mixing unitary can limit the algorithm's exploration to a subspace of the full Hilbert space. A QAOA ‘mixer’ is composed of Pauli-X operators acting on each qubit, and thus explores the entire Hilbert space which is exponentially larger than the space of valid solutions. In contrast, this disclosure provides a ‘hard mixer’ unitary U(β) that searches only among the valid permutation states by satisfying two primary desirable properties for a hard mixer:
1. For any β and σ∈Sₙ, | [symbol] y|U(β)|σ [symbol] |>0⇒y∈Sₙ, where σ is the encoded qubit representation of the solution σ. That is, if there is non-zero transition probability from a valid permutation state to another computational basis state, then that state must be valid.
2. For all σ₁∈Sₙ and σ₂∈Sₙ, there exists a β such that | [symbol] σ₂|U(β)|σ₁ [symbol] |>0. That is, for any two valid permutation states there must be some value β such that the transition probability between them is non-zero.

While constraining the search space enhances the optimisation algorithm, the circuit complexity is another consideration for NISQ devices. Higher circuit depths and larger numbers of noisy multi-qubit gates introduce compounding error and degraded algorithm performance.

As set out above, a quantum approximate optimization algorithm (QAOA) provides a means for solving combinatorial problems using current quantum computer architectures. The algorithm relies on a unitary U(β, γ), which is composed of two unitaries U(β)=e^{-iβH}^{_{B}} and U(γ)=e^{-iγH}^{_{P}}. H_{B} is referred to as the mixing Hamiltonian, which means it determines the exploration of the search space, while H_{P} is referred to as the problem Hamiltonian, which means it defines the optimality conditions of the solution. The two unitaries are applied iteratively in alternating manner to result in a final quantum state from an initial state. The initial state may be an equal superposition of all the basis states. Further information on QAOA is provided in Farhi, Edward, Jeffrey Goldstone, and Sam Gutmann. “A quantum approximate optimization algorithm.” arXiv preprint arXiv:1411.4028 (2014), which is incorporated herein by reference.

In quantum approximate combinatorial optimisation algorithms, mixing circuits provide the search space exploration element. These circuits can be used to search only among valid solutions to the problem by enforcing problem constraints to dramatically reduce the search space size. The resulting circuits may exhibit polynomial scaling of the circuit depth with the problem size. This disclosure provides a quantum mixing circuit with poly-logarithmic depth scaling on fully-connected hardware. A exponential depth reduction is obtained via modification of classical sorting networks combined with a binary permutation encoding and ancilla-based multi-qubit exponential swap operations. The circuit enforces general permutation-type constraints, which are suitable for problems including clustering and ordering.

### Overview

This disclosure provides a polylogarithmic-depth mixer that satisfies the desired hard mixer properties for quantum optimisation algorithms. As described below, the mixer design reduces the search space exponentially relative to the full Hilbert space. Additionally, the disclosed mixer has exponentially better depth scaling with the problem size than existing hard mixer implementations.

### Method

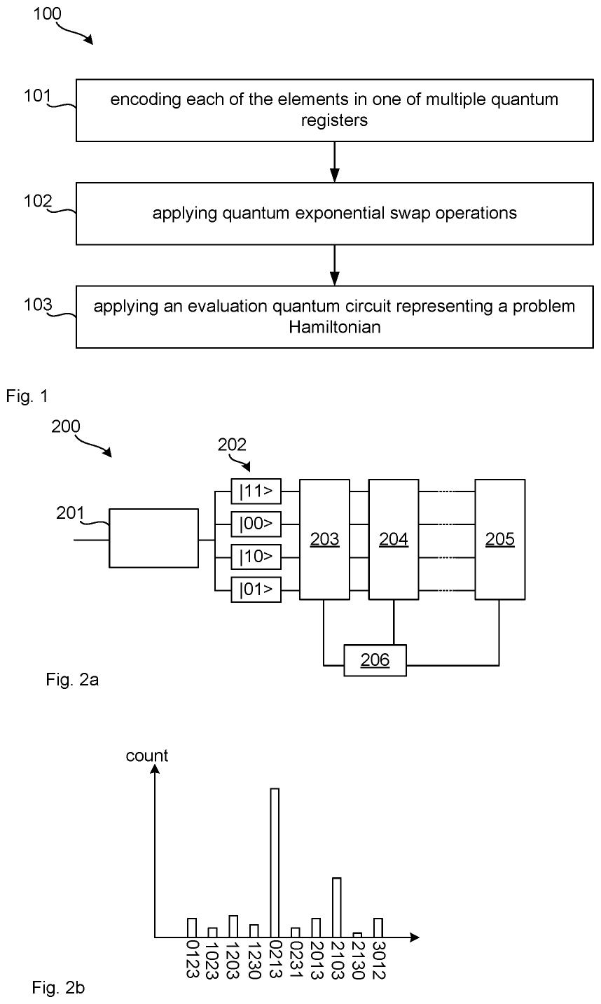

FIG. 1 illustrates a method for quantum approximate optimisation over permutations of a set of elements. For example, the permutations may be locations for a travelling salesman problem where each location is to be visited at least once while minimising the overall travel distance. Many other combinatorial optimisation problems can equally be used with this method.

The method commences by encoding 101 each of the elements in one of multiple quantum registers. For example, the method may assign a unique number to each element, such as an index. The index may be created by a counter that is incremented for each element. For the travelling salesman example, the locations to be visited are enumerated. Then, the method finds an encoding to convert or map the index into a combination of quantum states.

In one example, the encoding is binary, which means the method converts the index into a binary number, such as binary 0001 for decimal 1, binary 0010 for decimal 2 and so on. Of course, the indexing method, such as the counter, may already generate a binary encoding of the index “out of the box”. Each element is stored in one quantum register. So for example, if there are four elements 00, 01, 10 and 11, there are four quantum registers and each register stores two quantum bits (qubits). Each register may comprise stabiliser or error correction qubits and circuitry which will not be further described herein.

The quantum registers are considered in an ordered series such that the storing of the elements, as binary numbers, in the registers represents a permutation of the set of elements. So for example, the four registers may have stored, respectively: 11, 00, 10, 01 to represent the permutation 3, 0, 2, 1 as binary numbers. This is in contrast to one-hot encoding, which would be 0001, 0010, 0100, and 1000 to encode the four elements, respectively. Binary encoding provides a more compact representation and a significantly reduced number of required qubits.

FIG. 2a illustrates a quantum circuit 200 for quantum approximate optimisation over permutations of a set of elements. Quantum circuit 200 comprises an encoding logic 201 configured to encode each of the elements in one of multiple quantum registers as described above. This encoding logic 201 may comprise classical computing logic, i.e. Boolean logic or a digital processor to calculate the encodings. The result from the encoding logic 201 is written in quantum registers 202 such as by way of control signals to set the qubits in the registers to the appropriate states. It is noted that the quantum registers 202 may store a single permutation state as described above. In other examples, the encoding logic 201 creates multiple permutations in the quantum registers 202 in the sense that there is a superposition of states (i.e. a “superposition of permutations”).

Quantum circuit 200 further comprises a network 203 of quantum exponential swap operations configured to perform step 102 of method 100, that is, apply quantum exponential swap operations to respective pairs of the multiple quantum registers. Due to the use of the quantum registers 202 to represent a permutation of the encoded elements, applying the quantum exponential swap operations generates superpositions of permutations of the multiple quantum registers. That is, the network 203 does not result in a single re-ordering, shuffling or permutation of the registers 202 from one permutation to another. Instead, the swap operations are not ‘complete’ so that the resulting state of register 202 is a superposition of those permutations.

Further, there is an evaluation quantum circuit 204 to perform step 103 of applying the evaluation quantum circuit 204 to the registers 202. The evaluation circuit 204 represents a problem Hamiltonian to distinguish quantum states of the superposition generated by the network. More particularly, the evaluation circuit 204 applies a quantum phase to each state that is based on its quality. In combination with a classical computer that optimizes the variational parameters, the network 203 and the evaluation quantum circuit 204 amplify desirable quantum states and suppress undesirable quantum states to optimise over the permutations.

The network 203 and the evaluation circuit 204 are applied to the quantum registers multiple times, which is indicated in FIG. 2 by the dotted lines. This iterative application comprises alternating between mixing and evaluating, starting with either and ending with mixing. It is noted that the actual hardware, i.e. qubits and controls, are not implemented multiple times but the result of one iteration is fed back into the same circuit for the operations of the next iteration.

### Measurement

Finally, there is a measurement circuit 205 that measures the quantum states in the registers 202. That is, the measurement circuit 205 measures which quantum states (i.e. permutations) are in the superposition as a result of applying the mixing circuit 203 and evaluation circuit 204. The measurement is performed after multiple iterations of applying the mixing network 203 and the evaluation circuit 204 to the registers 202, noting that the first operation may be the mixing or the evaluation while the last operation is the mixing.

Since measuring the quantum state in registers 202 collapses the superposition into one of the computational basis states, the method is performed multiple times to obtain multiple measurements. Each measurement is one computational basis state, such as |(00)(10)(01)(11)>, and the measurement circuit 205 counts the occurrence of each computational basis state for the multiple repetitions.

FIG. 2b illustrates a histogram of measured ground states, i.e. permutations, over time (not all permutations are shown). It can be seen that the most frequent measured state relates to the permutation 0213, that is, the quantum state |(00)(10)(01)(11)>. This is the result of search space exploration by the mixing network 203 and state-dependent quantum phases applied by the evaluation circuit 204. Under optimization of circuit variational parameters, this result indicates that the permutation 0213 is the best obtained solution to the problem, noting that the result is an approximation, so there may exist better solutions. It is noted that the control of the repetitions and the measurement and counting is performed by a mixture of quantum and classical elements. This means, the encoding logic 201 and the measurement circuit include classical electronic components while the register 202, network 203 and evaluation circuit 204 are quantum computing components.

Additionally, there is a classical optimization circuit 206, such as a classical computer system programmed to operate the quantum circuit, that uses the measurements to determine the variational parameters for the quantum circuit. This classical optimization is used to refine the amount of mixing performed by each mixing network 203 and the amount of state-dependent phase applied by each evaluation circuit 204. The optimization is applied such that better solutions are measured. In this way, the probability of measuring the optimal solution can be amplified by the mixing and evaluation circuits.

More specifically, for a given iteration of the classical optimization, the quantum circuit is measured multiple times, and the resulting measurement distribution is used to generate a single number (optimization cost), which can be the expectation value or some other function of the measurement distribution (which can often improve performance). The optimization cost is fed into some choice of classical optimizer (e.g. Constrained Optimization BY Linear Approximation (COBYLA) algorithm, an optimizer available in the scipy.optimize.minimize package) to return a new set of variational parameters for testing. The classical optimizer pairs the variational parameters with the associated optimization cost, and uses its particular method to choose the next variational parameters in a way that should lead to improved optimization costs over time. The next set of variational parameters are used to construct the new quantum circuit, and the next iteration begins. The total number of iterations may vary, and typically depends on the problem and the convergence criteria of the classical optimizer. Once the convergence criteria of the classical optimizer is met, the process terminates and the best obtained result is provided.

### Sorting Networks

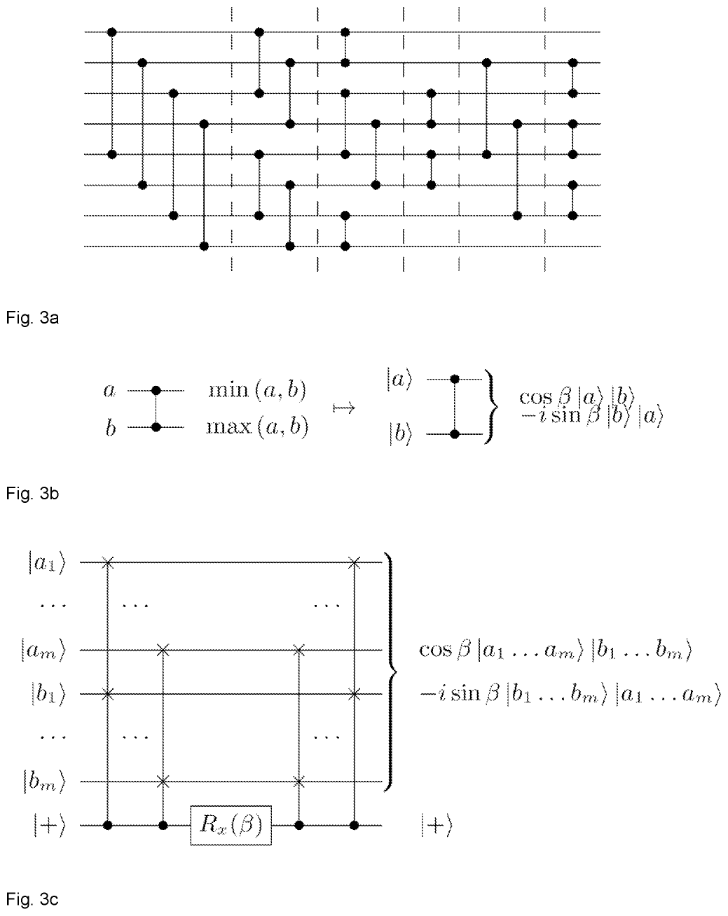

One approach for network 203 is to use quantisation and modification of a classical sorting network. The sorting network could be an odd-even mergesort network, bubble sort, or other sorting network. In general, a sorting network is a fixed series of pairwise comparators, as displayed in FIG. 3a, such that any n-length input to the network is output in sorted order. Each comparator swaps its two inputs if they are in descending order. Sorting networks have a fixed architecture for a given n, and are generally structured to maximise the parallelisation of the comparators. The asymptotically optimal sorting networks have depth [symbol] (log n) and comparator count [symbol] (n log n).

The quantisation of the sorting network to a mixer U(β) is as follows (see below). The circuit 200 starts by the encoding logic 201 converting the input wires of the sorting networks to quantum registers 202 of size m=log₂n, each encoding a label from 0 to n−1. For example, a permutation {0→0,1→3,2→1,3→2} applied to 4 elements would be represented by the state 0312=|(00)(11)(01)(10) [symbol] . This is a different example to that shown in FIG. 2.

The comparators of the classical sorting network architecture are replaced with unitary ‘exponential swap’ operations in network 203. These operations are parameterised by an evolution parameter β (FIG. 3b), such that |ab [symbol] [symbol] e_{-βSWAP}| ab [symbol] . Here, SWAP|ab [symbol] =|ba [symbol] is the swap operation between each pair of bits in two multi-qubit registers. Parameter β may be fixed to be the same for all pairwise operations, and is defined as the classical variational parameter associated with the mixer. The essential unitary evolution of the multi-qubit SWAP operation can be implemented using a single ancilla qubit, displayed FIG. 3c.

It is noted that for a sorting network architecture, the proposed mixer satisfies the properties of a mixing unitary. Applying the mixer to a valid permutation state σ with σ∈Sₙ, there is [symbol] y|U(β)|σ [symbol] |>0⇒y∈Sₙ since swapping (or exponential swapping) the location of two registers in the qubit encoding maintains the validity of the encoded permutation. Satisfaction of the second criteria follows directly from the correctness of classical sorting networks, where for a valid permutation σ₁ we have

$$U ( β ) {σ}_{1} = {\sum }_{{σ}_{2} ∈ {S}_{2}} {α}_{{σ}_{2}} ( β ) {σ}_{2} \qquad ( 1 )$$

with complex coefficient terms α_{σ}_{₂}(β) that are comprised of sums of products of −i sin(β) and cos(β) terms. For any given permutation σ₂∈Sₙ, it can be ensured that | [symbol] ₂|U(β)|σ₁ [symbol] >0 by choice of β that avoids destructive interference.

### Advantages

The size and depth of each exponential swap operation used in this example mixer scales linearly in the size of the registers, indicating the advantage of the efficient binary permutation encoding (log n qubits per register), as opposed to the one-hot encoding (n qubits per register). Note that although a single ancilla qubit suffices if all pairwise operations are applied in sequential order, to retain polylogarithmic depth for the quantum mixer a total of n/2 ancillas can be used to accommodate maximum parallelisation of swaps between register pairs.

Using an asymptotically optimal sorting network architecture, the disclosed method leads to a mixing circuit using [symbol] (n log n) total qubits including ancillas, [symbol] (n log²n) controlled-swap gates, and [symbol] (log²n) depth. In contrast to previous permutation-based mixing approaches, this is an exponential reduction in the mixing circuit depth. In addition, using the binary labelling approach rather than the one-hot encoding leads to a near-quadratic reduction in the required number of qubits. A comparison of the sorting-based mixer to previous standard approaches for permutations is shown in Table 1 below.

TABLE 1
Comparison of the disclosed sorting-based approach to previous
approaches for permutation-based quantum mixing circuits.

| | | Search | Circuit | Circuit |
|---|---|---|---|---|
| Approach | Qubits | space | size | depth |
| Default | n² | 2ⁿ^{²} | [symbol] (n²) | [symbol] (1) |
| (one-hot) | | | | |
| Default | n┌log₂n┐ | 2^{n┌log}^{₂}^{n┐} | [symbol] (┌nlog₂n┐) | [symbol] (1) |
| (binary) | | | | |
| Color-parity | n² | n! | [symbol] (n⁴) | [symbol] (n³) |
| ring | | | | |
| Grover Mixers | n² | n! | [symbol] (n³) | [symbol] (n²) |
| for QAOA | | | | |
| Sorting (this | n┌log₂n┐ + | n! | [symbol] (nlog₂² n) | [symbol] (log₂² n) |
| disclosure) | └n/2┘ | | | |

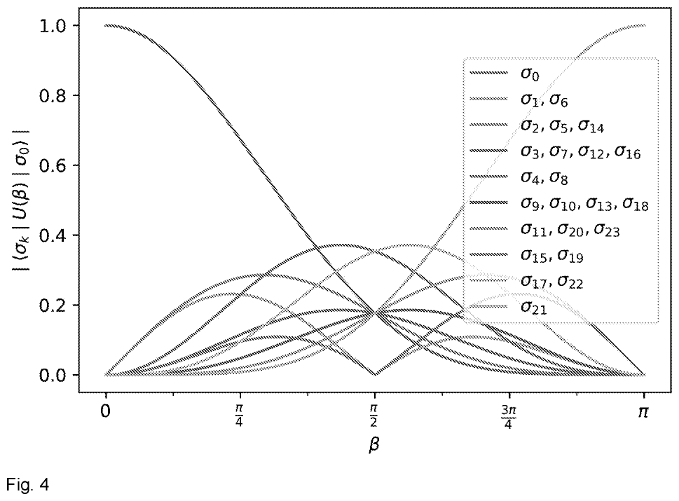

It is possible to verify that for any given sorting network architecture, the disclosed mixer satisfies the essential properties of a mixing unitary, as shown above. Thus, method 100 achieves the two primary mixing goals in polylogarithmic circuit depth. These properties are illustrated in FIG. 4 for a problem involving permutations on 4 elements, using Batcher's odd-even mergesort network architecture. In addition to illustrating the probability transfer between any two pairs of permutations, this plot demonstrates the high symmetry of the mixer with respect to the n! valid permutations. The high symmetry illustrated here is a desirable property for a quantum mixer since it minimises undesirable bias introduced in the optimisation process, where solution states are amplified differently, independently of their quality.

Finally, it is noted that there is a choice of specific sorting network architectures and the implications for use as a mixer. Due to the large constants involved in the size of the asymptotically optimal sorting networks, it is useful to choose sorting networks with asymptotically poorer depth scaling (although still polylogarithmic) that have much smaller sizes in practice. A choice is Batcher's odd-even mergesort network, illustrated in FIG. 3a. This network requires [symbol] (log²n) depth and [symbol] (n log²n) comparators. Other well-known sorting networks include the bitonic sort (depth [symbol] (log²n)), and the bubble and odd-even transposition sorting networks. The latter two networks have depth [symbol] (n), eliminating the exponential depth reduction. However, these two networks only use pairwise comparisons between adjacent registers and thus are naturally suited to compilation on near-term quantum hardware with highly restricted qubit connectivity.

### CONCLUSION

This disclosure provides a new hard mixer for quantum approximate optimisation designed for discrete optimisation over permutations of a set of n elements. The disclosed method uses a binary qubit encoding of element labels, and obtains the quantum mixing circuit through an adaption of a classical sorting network architecture, replacing the comparators with ancilla-based ‘exponential swap’ operations between label registers. The depth of the quantum mixing circuit is polylogarithmic with respect to n, making it exponentially faster than previous approaches. The mixer is directly compatible to any problem where swapping the labels of any two elements maintains the validity of the solution, making it applicable to a wide range of important real-world problems including clustering, capacitated vehicle routing, and scheduling.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A quantum circuit for quantum approximate optimisation over permutations of a set of elements, the quantum circuit comprising:
multiple quantum registers, each of the multiple quantum registers comprising multiple qubits;
an encoding logic configured to encode each of the elements in one of the multiple quantum registers as a binary number to represent a permutation of the set of elements by storing the binary number of each of the elements in an order according to the permutation;
a network of multi-qubit quantum exponential swap operations, each one of the multi-qubit quantum exponential swap operations configured to:
operate between the multiple qubits of a first quantum register of the multiple quantum registers and the multiple qubits of a second quantum register of the multiple quantum registers, and
generate a superposition of two permutations by generating a superposition of two binary numbers by generating a superposition of the multiple qubits of the first quantum register storing a first binary number and the multiple qubits of the second quantum register storing a second binary number; and
an evaluation quantum circuit representing a problem Hamiltonian to distinguish quantum states of the superposition generated by the network, wherein when in use, the network and the evaluation quantum circuit amplify desirable quantum states and suppress undesirable quantum states to optimise over the permutations.

2. The quantum circuit of claim 1, wherein the network of quantum exponential swap operations has a structure of a sorting network.

3. The quantum circuit of claim 2, wherein the structure comprises an odd-even mergesort structure.

4. The quantum circuit of claim 1, wherein the network is configured to transform any valid permutation state to a quantum superposition of computational basis states, and wherein each computational basis state with non-zero probability in the superposition is a valid permutation state.

5. The quantum circuit of claim 1, wherein the network comprises a quantum exponential swap operation with non-zero probability between any two valid permutation states.

6. The quantum circuit of claim 1, wherein the quantum exponential swap operations are tuneable by a parameter indicating the degree of swap in the superposition.

7. The quantum circuit of claim 6, wherein the parameter is a quantum evolution parameter.

8. The quantum circuit of claim 6, wherein the action of the circuit is dependent on the series of the swap parameters, which can either be identical or independently tunable for a given network.

9. The quantum circuit of claim 1, wherein the network of multi-qubit quantum exponential swap operations further comprises a single ancilla qubit to implement a series of quantum swap operations between the first quantum register and the second quantum register.

10. The quantum circuit of claim 9, wherein the network of multi-qubit quantum exponential swap operations further comprises n/2 ancilla qubits to implement the series of quantum swap operations between multiple registers in parallel, where n is a number of elements.

11. The quantum circuit of claim 1, wherein the evaluation quantum circuit is configured to apply a phase shift to solutions proportional to a respective quality.

12. The quantum circuit of claim 11, wherein the phase shift is tuneable by an evaluation parameter.

13. The quantum circuit of claim 1, wherein the quantum circuit further comprises control circuitry to iteratively optimise an initial permutation by applying the quantum swap operations and the evaluation quantum circuit multiple times until a termination criterion is met.

14. A method for quantum approximate optimisation over permutations of a set of elements, the method comprising:
encoding each of the elements in one of multiple quantum registers as a binary number, each of the multiple quantum registers comprising multiple qubits, by storing the binary number of each of the elements in an order according to a permutation of the set of elements;
applying multi-qubit quantum exponential swap operations between the multiple qubits of a first quantum register of the multiple quantum registers and the multiple qubits of a second quantum register of the multiple quantum registers, to generate a superposition of two permutations by generating a superposition of two binary numbers by generating a superposition of the multiple qubits of the first quantum register storing a first binary number and the multiple qubits of the second quantum register storing a second binary number; and
applying an evaluation quantum circuit representing a problem Hamiltonian to amplify desirable quantum states of the superposition generated by the network and to suppress undesirable states of the superposition generated by the quantum network to optimise over the permutations.

15. The method of claim 14, wherein the method further comprises measuring a result of applying the quantum exponential swap operations and the evaluation quantum circuit to optimise over the permutations based on the result.

16. The method of claim 14, wherein the method further comprises iteratively optimising an initial permutation by, at each iteration, tuning quantum circuit parameters by a classical computer system.
